(19) United States
(12) Patent Application Publication
(10) Pub. No.: US 2011/0043351 A1
(43) Pub. Date: Feb. 24, 2011

(54) method of visually representing the variation over time of a current difference between a real value and an optimum value for a parameter, using at least three activatable light signals

(75) Inventors: Jean-Laurent Franchineau, Paris (FR); Emmanuel De Verdalle, Paris (FR); Vincent Martin, Paris (FR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: EUROLUM, Paris (FR)

(21) Appl. No.: 12/989,936

(22) PCT Filed: Apr. 28, 2009
(86) PCT No.: PCT/EP09/55130

§ 371 Date: Oct. 27, 2010

(30) Foreign Application Priority Data
Apr. 30, 2008 (FR) 0852924

(51) Int. Cl. B60Q 1/00; G08B 21/00

(52) U.S. Cl. 340/441; 340/664

(57) ABSTRACT

The invention relates to a method of visually representing the variation over time of a difference between a real value of a parameter and an optimum value thereof using at least three activatable light signals, said method comprising:
a first transition step (105) that is performed if the current range of values is contiguous with a prior range of values, in which step, after a first delay has elapsed, the signal associated with the prior range of values is deactivated and the light signal associated with the current range of values is activated; and
a second transition step (107) that is performed if the current range of values is not contiguous with the prior range of values, during which step, after a second delay has elapsed, the light signal associated with the prior range of values is deactivated and the light signal associated with an intermediate range of values corresponding to a range of values contiguous with the prior range of values, is activated, and then after a third delay has elapsed, the light signal associated with the intermediate range of values is deactivated and the light signal associated with the current range of values is activated.

The present invention relates to the field of man-machine interfaces, and in particular those for assisting in the control of a vehicle.

The present invention relates more precisely to a method for implementing in a man-machine interface on board a land vehicle such as a bus, a tram, a train, or any other type of land vehicle.

Vehicles of this type are generally controlled by a human driver who sets the operating parameters of the vehicle such as, for example: its speed, acceleration, or engine revolutions, as a function of the route and also as a function of the human's experience and skill as a driver. The driver also takes account of certain constraints such as an imposed duration for traveling the route or indeed the energy available for traveling the route.

Given all that data, it is unusual for a driver to be able to control the vehicle while also optimizing one or more parameters.

Various methods exist for assisting in the control of a vehicle to enable an optimum value to be determined of a parameter for a current position of the vehicle, and consequently a current difference between said optimum value and a real value of the parameter for said current position of the vehicle.

The term “current position” is used to mean the position of the vehicle at a current instant.

An object of the present invention is to provide a method of visually representing variation over time in said current difference by using at least three activatable light signals.

The invention achieves this object by the fact that the method comprises:
a reception step of receiving the current difference;
a definition step during which at least three contiguous ranges of values are defined and each of these ranges of values is associated with a respective one of the light signals;
a determination step of determining the current range of values as the range of values in which the current difference lies;
a first transition step that is performed if the current range of values is contiguous with a prior range of values, in which step, after a first delay has elapsed, the signal associated with the prior range of values is deactivated and the light signal associated with the current range of values is activated; and
a second transition step that is performed if the current range of values is not contiguous with the prior range of values, during which step, after a second delay has elapsed, the light signal associated with the prior range of values is deactivated and the light signal associated with an intermediate range of values corresponding to a range of values contiguous with the prior range of values, is activated, and then after a third delay has elapsed, the light signal associated with the intermediate range of values is deactivated and the light signal associated with the current range of values is activated.

In the invention, the current range of values is the range of values in which the current difference lies at the current instant, whereas the prior range of values corresponds to the range of values in which the current difference was lying at the preceding instant. In other words, the prior range of values is the previous current range of values.

In the meaning of the present invention, the term “contiguous” is used to mean that the prior range of values has a single value in common with the current range of values. Preferably, the common value is the bottom limit of one of the two ranges and the top limit of the other range of values.

In the method, no transition step is performed if the current range of values is identical to the prior range of values.

It can also be understood that the second transition step is performed only if the current range of values and the prior range of values do not share a value in common, i.e. when the intersection of these two ranges is empty.

By means of the present invention, the driver is informed in real time about the variation over time of the current difference in such a manner as to enable the driver to act on the controls of the vehicle so as to correct the difference by reducing it or even eliminating it. When the driver acts on the controls of the vehicle, the real value of the parameter is modified, and as a result the difference between the real value and the optimum value varies.

In this method, one of the three light signals serves to indicate that the difference is acceptable, while the other two light signals serve to indicate that the difference between the real value and the optimum value is unacceptable such that the driver needs to modify driving behavior in order to reduce the difference. One of these two other light signals may preferably indicate that the unacceptable difference is positive, i.e. that the real value exceeds the optimum value by too much, while the other light signal serves to indicate that the unacceptable difference is negative, i.e. that the real value falls short of the optimum value by too much. In other words, taking the particular example of the parameter being speed, when the light signal that informs the driver of an unacceptable positive difference is activated, that means that the real speed is faster than the optimum speed by too much and thus that the driver must slow down. Conversely, when the light signal that serves to inform the driver of an unacceptable negative difference is activated, that means that the real speed is slower than the optimum speed by too much and thus that the driver must accelerate in order to reduce the current difference.

It can also be understood that it is the light signal associated with the current range of values that is activated in order to give the driver a visual representation of said current difference.

Thus, the first transition step corresponds to a small variation in the current difference, while the second transition step corresponds to a relatively greater variation in said difference.

In the invention, the second transition step leads to temporary activation of at least one light signal that is associated with the intermediate range of values. This second transition presents the advantage of providing the driver with information that varies gently rather than suddenly. In the event of a significant variation in the difference, the driver might be surprised by a light signal being activated indicating that the current difference has suddenly become unacceptable. On the contrary, the method of the invention informs the driver progressively and continuously about the variation in the difference by activating one or more intermediate signals associated respectively with one or more intermediate ranges of values.

Preferably, each light signal is preferably made up of one or more light-emitting diodes (LEDs), preferably three adjacent LEDs. Nevertheless, it is possible to provide other arrangements of LEDs or of any other members suitable for emitting light.

Advantageously, the second delay is equal to the third delay so as to represent progressive variation of the variation of the difference during the second transition step.

Preferably, the second delay is equal to half the first delay. As a result, the third delay, which is equal to the second delay, is equal substantially to half the first delay. The duration of the second transition step is thus equal to the duration of the first transition step. In other words, the light signal associated with the intermediate range of values remains switched on for half the time that the light signal associated with the prior range of values remains switched on.

The advantage is to make it possible to inform the driver quickly when there is a large variation in the difference. Although the driver must not be surprised, it is nevertheless important to inform the driver rapidly of such variation, and this is achieved by the invention.

In general manner and on the same lines, it is preferable to provide for the sum of the second and third delays to be equal to the first delay.

Another advantage of having a second transition step that is as fast as the first transition step is to be able to provide the driver with information that is accurate. If the second transition step were too slow, then the current difference might already have varied by the time the light signal corresponding to the current range of values is activated, which would mean that the information provided was wrong.

In a variant of the invention, the first transition step is performed if the current difference lies in a sub-range of the current range of values that is not contiguous with the prior range of values.

In other words, the first transition step is performed only if the variation in the difference is greater than a predetermined threshold, which threshold corresponds to the difference between the prior range of values and the sub-range of the current range of values.

This serves to avoid the light signals flashing in unwanted manner if the difference varies by passing quickly from one range of values to another range of values that is contiguous therewith. By means of the invention, the difference thus varies with hysteresis.

Advantageously, the first and second transition steps are not performed if the current difference is greater than a predetermined limit value. This makes it possible to deactivate the method as soon as the driver takes the initiative to control the vehicle without seeking to optimize the parameter. By way of example, such circumstances may be encountered if the driver needs to avoid an obstacle or carry out an unforeseen maneuver. Under such circumstances, it is preferable to activate two light signals associated with two non-contiguous ranges of values, with this particular configuration informing the driver that the method is temporarily deactivated.

In accordance with the invention, the parameter comprises at least one magnitude, in particular a speed. Thus, the parameter may be constituted solely by speed or it may be constituted by a combination of values selected from speed, acceleration, engine revolutions, or any other magnitude commonly found in vehicles and that relates to an operating characteristic of the vehicle.

Preferably, each of the ranges of values is defined from the optimum value of the parameter. Thus, and preferably, the ranges of values are redefined over time for each optimum value of the parameter.

Advantageously, each of the ranges of values has a bottom limit and a top limit that depend on the optimum value of the parameter.

In other words, each of the ranges of values lies between its bottom limit and its top limit.

For example, the bottom and top limits of a range of values may be proportional to a multiple of the optimum value of the parameter, with the proportionality factor possibly depending on the optimum value of the parameter. The limit values may also be predetermined fixed values.

The present invention also provides a display interface including a device implementing the visual representation method of the invention, a receiver member for receiving a current difference, a calculation device for defining at least three ranges of values, and at least three light signal emitters associated with the ranges of values.

Preferably, each of said light signal emitters is constituted by at least one light-emitting diode.

Preferably, each of said light signal emitters is constituted by a group of three LEDs, it being understood that two light signals associated with two contiguous ranges of values preferably have two diodes in common, and that two ranges of values separated by a single intermediate range of values have one diode in common. Such an arrangement serves to give the driver a visual effect that is progressive and continuous.

For example, provision may be made for the interface to include in succession three red diodes, three green diodes, and three red diodes.

Finally, the invention provides an urban vehicle for following a route, which vehicle includes a display interface of the invention, a speed sensor for measuring a real speed of the vehicle, a memory containing a plurality of optimum speeds, a calculation member for calculating a current difference between the real speed and the optimum speed corresponding to the current position of the vehicle, and for transmitting it to the receiver member of said display interface.

The invention can be better understood and its advantages appear better on reading the following detailed description of two embodiments given by way of non-limiting example. The description refers to the accompanying drawings, in which:

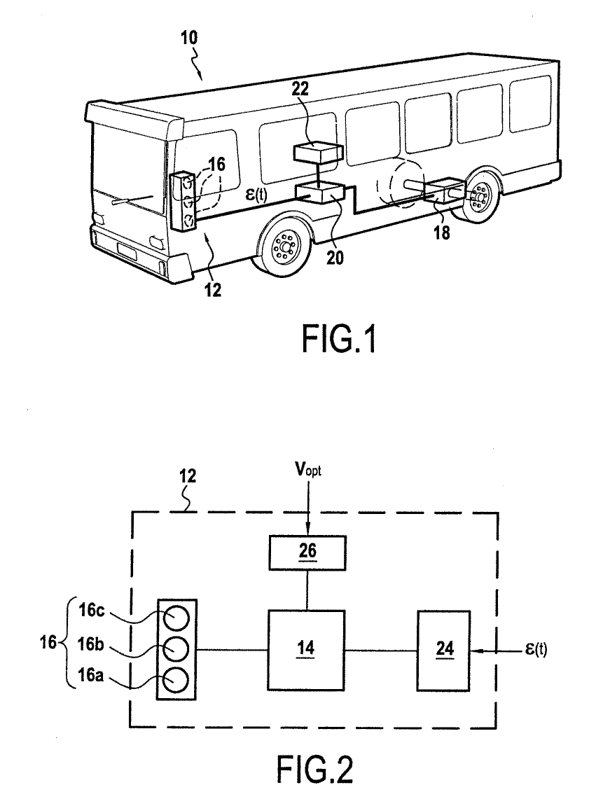

FIG. 1 shows an urban vehicle in accordance with the present invention and including a display interface also in accordance with the invention;

FIG. 2 is a diagram of a display interface mounted in the vehicle of FIG. 1;

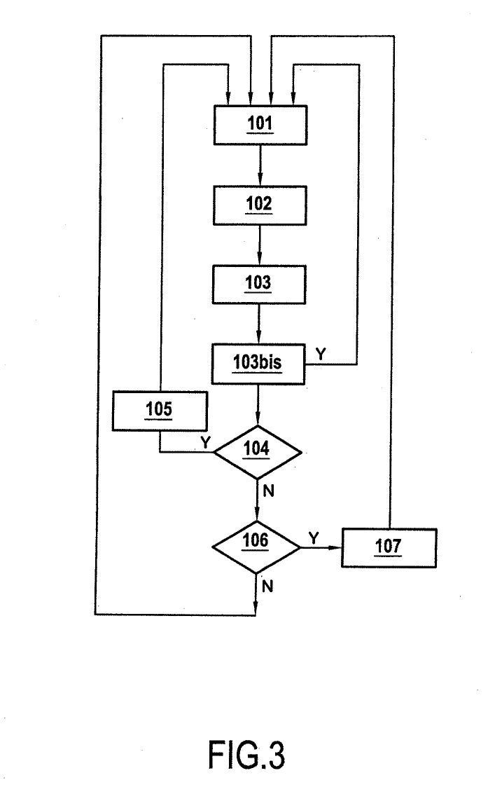

FIG. 3 is a flow chart showing the steps of the visual representation method of the invention;

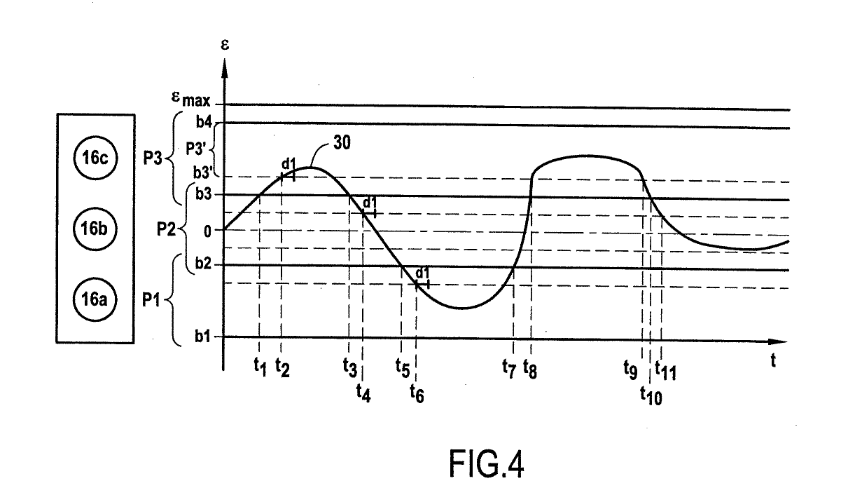

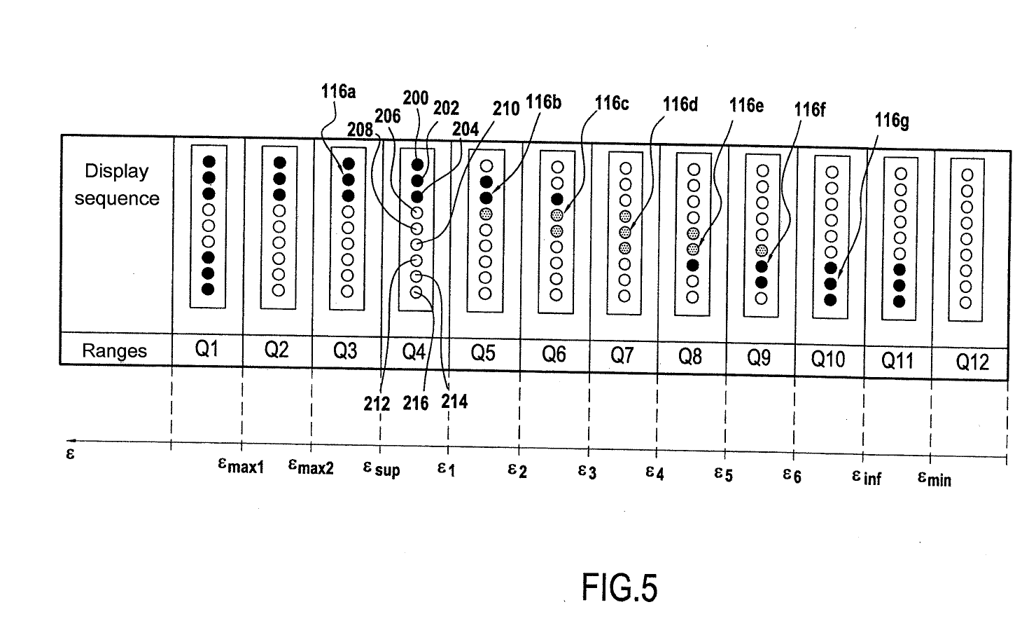

FIG. 4 is a graph showing how the difference varies over time; and

FIG. 5 shows the various configurations that can be taken up by the display interface in a second embodiment of the invention.

FIG. 1 shows an urban vehicle 10, specifically a city bus, that is fitted with a display interface 12 in accordance with the present invention.

This display interface 12, shown in detail in FIG. 2, serves to assist the driver in real time in the control of the vehicle 10. More precisely, the display interface 12 informs the driver whether driving is optimal or not. For this purpose, the display interface 12 includes a device 14 implementing the method of visually representing variation in time of a difference between a real value and an optimum value of a parameter, specifically the speed of the vehicle, using three activatable light signals 16. Naturally, other types of parameter or driving profile could be selected that are constituted by one or more magnitudes taken from acceleration, engine revolutions, or any other magnitude characteristic of the operation of an urban vehicle.

At this point it should be specified what is meant by optimum speed. By way of example, the optimum speed may correspond to the speed of the bus that minimizes its energy consumption and the time taken to travel a determined route in a given time. Reference may be made to French patent application Ser. No. 07/56076 filed by the present Applicant for further details.

The three light signals 16a, 16b, and 16c are here in the form of a two-color lamp having three diodes: red (diode 16a)-green (diode 16b)-and red (diode 16c) disposed in a vertical column. Nevertheless, provision could be made for a lamp to present a larger number of light signals.

According to the invention, when the green diode 16b is activated (on), that means that the real value of the speed of the vehicle 10 corresponds substantially to the optimum speed for the vehicle 10. Furthermore, when the difference ε between the real speed and the optimum speed is greater than a first predetermined threshold b3, one of the light signals associated with a red diode, preferably the top diode 16a, is activated. In this situation, the vehicle 10 is running too fast relative to the optimum speed that it ought to present at this point along its route.

The driver is thus invited to slow the vehicle down until the green diode 16b is activated.

Similarly, when the difference ε between the real speed and the optimum speed is below a second predetermined threshold b2, one of the light signals associated with the other red diode, preferably the bottom diode 16c, is activated. In this situation, the vehicle 10 is running too slowly compared to the optimum speed it ought to present at this location on the route.

The driver is thus invited to accelerate the vehicle until the green diode 16b is activated.

It can thus be understood that by means of the present invention, the vehicle 10 may present a driving profile that is optimum all along the route.

There follows a description in greater detail of the structure and the operation of the interface of the invention.

Firstly, the real speed for a current position of the vehicle, i.e. the (current) real speed, is measured by a speed sensor 18 that is mounted on one of the axles of the vehicle 10, or is taken from a multiplexed bus of the bus, or indeed is obtained using a global positioning system (GPS). This also includes a calculation member 20 for calculating a current difference ε between the real speed and the optimum speed Vopt for the current position, it being specified that the value of the optimum speed is stored in a memory 22 containing a plurality of optimum speeds. The memory and the calculation member are described in greater detail in the above-mentioned patent application, to which reference may be made.

The current difference ε is transmitted to the display interface 12, as shown diagrammatically in FIG. 1.

In this example, the current difference 6 is transmitted to a receiver member 24 of the display interface 12.

The calculation device 26 of the display interface 12 defines three contiguous ranges of speed values starting from the optimum speed Vopt for the current position. These ranges of values are referenced herein as P1, P2, and P3. The idea is to associate each of these ranges of values with one of the light signals and to activate the light signal that corresponds to the range of values in which the current difference lies, i.e. the current range of values.

Thereafter, on the basis of these ranges of values and of the current difference ε, the device 14 determines which of the three light signals is to be activated.

With reference to FIG. 3, there follows a more detailed description of the method of the invention.

As mentioned above, in this implementation, the method of the invention consists in a visual representation of the way the difference between the real value of the speed of the vehicle 10 and the optimum value for said speed varies over time by using three light signals 16a, 16b, and 16c.

To do this, the method firstly comprises a step 101 of receiving the current difference, specifically via the receiver member 24.

Thereafter, a definition step 102 is performed during which three consecutive ranges of values P1, P2, and P3 are defined.

The ranges of values P1, P2, and P3 are contiguous in the sense that the top limit b2 of the range P1 corresponds to the bottom limit b2 of the range P2, and the top limit b3 of the range P2 corresponds to the bottom limit b3 of the range P3.

Specifically, the top limit b3 of the range P2 corresponds to the above-mentioned first predetermined threshold, while the bottom limit b2 of the range P2 corresponds to the above-mentioned second predetermined threshold.

Furthermore, reach of these ranges of values is associated with a respective one of the light signals 16a, 16b, 16c. Thus, the range of values P1 is associated with the light signal 16a, the range of values P2 with the light signal 16b, and the range of values P3 with the light 16c.

In the example shown in FIG. 3, the ranges P1, P2, and P3 are preferably selected as percentages of the optimum speed value. For example, the limit b3 corresponds to 110% of the optimum speed, the limit b4 corresponds to 120% of the optimum speed, the limit b2 corresponds to 90% of the optimum speed, and the limit b1 corresponds to 80% of the optimum speed.

Thereafter, during a step 103, it is determined which range of values P1, P2, or P3 contains the current difference ε.

For example, if the current difference is 105%, that means that the real speed value exceeds the optimum value by 5% so the current difference lies in the range P2. If the current difference is 112% then it lies in the range P3, and if the current difference is 90% (which means that the real value of the speed corresponds to 90% of the current value), then it lies in the range P1.

Without going beyond the ambit of the present invention, it is entirely possible to provide other configurations of ranges by selecting other methods or determining thresholds.

There follows a description of an important aspect of the present invention.

While the vehicle 10 is traveling, it happens frequently that the current difference fluctuates over time, as shown in FIG. 4. In this figure, the curve 30 presents how the current difference ε varies over time. In this example, it can be seen that the difference ε initially lies in the range P2 (between t=0 and t=t1), and then increases so as to lie in the range P3 between t1 and t3.

Between 0 and t1, while the current difference ε lies in the range P2, the light signal 16b (green diode) is activated. This is a first state.

Between t1 and t3, while the current difference ε lies in the range P3, the light signal 16c (red diode) is activated. This is a second state.

According to the invention, the transition between the first state and the second state takes place via a first transition step 105. For this transition, the prior range of values is the range P2, while the current range of values is P3, since that is a range in which the current difference ε lies immediately after the instant t1. In general, this first transition step 105 is performed if, during a test step 104, it is found that the current range of values is contiguous with the prior range of values, as is true in this situation: the range P3 is contiguous with the range P2.

During this first transition step, after a first delay d1 has elapsed, the light signal 16b (green diode) associated with the prior range of values P2 is deactivated (turned off) and the light signal 16c (red diode) associated with the current range of values P3 is activated (switched on).

Preferably, the delay d1 lies in the range 600 milliseconds (ms) to 1000 ms, and is preferably 800 ms.

In a variant, a hysteresis type transition may be provided whereby, in order to avoid untimely flashing of the light signals 16b and 16c, if the current difference is varying around the value b3, provision is made for the first transition step to be performed only if the current difference lies in a sub-range of the current range of values that is not contiguous with the prior range of values. Specifically, the first transition step is performed after the current difference has become greater than the threshold b3′ (at instant t2), i.e. the current difference lies in the sub-range P3′ that is not contiguous with the range P2 since it is spaced apart therefrom.

With reference once more to FIG. 4, it can be seen that the current difference decreases to return to the range P2 after instant t3.

It can be understood that a first transition step is performed once more, during which, after the first delay d1 has elapsed, the light signal 16c (red diode) is deactivated and the light signal 16b (green diode) is activated. Preferably, this new first transition step is performed a little after instant t3, i.e. after instant t4, for the same reasons as those mentioned above, i.e. to avoid untimely flashing.

Thereafter the current difference continues to decrease and moves into the range P1 after instant t5, and it can be understood that a new first transition step is performed after instant t5 (preferably after t6) such that after the first delay d1 has elapsed, the light signal 16b (green diode) is deactivated and the light signal 16a (red diode) is activated.

Thereafter, it can be seen that the current difference increases suddenly, since it passes very quickly from the range P1 to the range P3. In other words, the duration between the instant t7 and the instant t8 is very fast. In order to provide the driver with information that varies progressively, the invention advantageously makes provision for a second transition step 107 that is performed (test step 106) if the current range of values is not contiguous with the prior range, as occurs under these circumstances since the current range of values P3 is not contiguous with the prior range of values P1.

More precisely, the second transition step is performed when the acceleration of the vehicle is greater than a first predetermined threshold, e.g. 2 meters per second per second (m/s²) and/or when the deceleration of the vehicle is greater than a second predetermined threshold of the order of 2.5 m/s². During this second transition step 107, after a second delay d2 has elapsed, the light signal 16a associated with the prior range of values P1 is deactivated and the light signal 16b (green diode) associated with the range of values contiguous with the prior range of values P1, i.e. specifically the range of values P2, is activated. This range of values P2 that is contiguous with the prior range of values P1 is referred to as an intermediate range of values.

Thereafter, after a third delay d3 has elapsed, the light signal 16b (green diode) associated with the intermediate range of values P2 is deactivated and the light signal 16c (red diode) associated with the current range of values P3 is activated.

This produces a progressive transition when the current difference varies suddenly.

Preferably, the second delay is equal to the third delay and, advantageously, the sum of the second and third delays is equal to the first delay.

In other words, the duration of the first transition step 105 is advantageously equal to the duration of the second transition step 107, thereby supplying the driver with information that is progressive and fast regardless of how the current difference is varying.

Furthermore, and preferably, the first and second transition steps 105 and 107 are not performed if the current difference is greater than a predetermined limit value εmax. A test is provided during an additional step 103bis that is preferably performed before the step 104.

Preferably, provision is also made for special signaling if the real speed of the vehicle exceeds the legally allowed speed, e.g. by simultaneously activating both light signals 16a and 16c (red diodes).

Similarly, provision could be made for the first and second transition steps 105 and 106 not to be performed if the current difference is less than a predetermined limit value εmin. Under such circumstances, the vehicle 10 is running too slowly and is probably maneuvering so there is no advantage informing the driver that the vehicle is not running at the optimum speed. Such a test is provided, e.g. likewise during the additional step 103bis.

In FIG. 5, there can be seen the various configurations that may be taken by the light signals in a display interface in a second embodiment of the invention.

In this second embodiment, there are provided twelve ranges of values numbered Q1 to Q12 in FIG. 5, together with seven distinct light signals, each of the light signals being generated by three adjacent color diodes. For this purpose, the interface comprises specifically three successive red diodes 200, 202, 204, three successive green diodes 206, 208, 210, and three red diodes 212, 214, 216.

The first light signal 116a is associated with the ranges Q2 to Q4. It is made up of three red diodes 200, 202, and 204.

The second light signal 116b is associated with the range Q5 and is made up of two red diodes 202 and 204, together with the green diode 208.

The third light signal 116c is associated with the range Q6 and is made up of the red diode 204 and the two green diodes 206 and 208.

The fourth light signal 116d is associated with the range Q7 and is made up of the three green diodes 206, 208, 210.

The fifth light signal 116e is associated with the range Q8 and is made up of two green diodes 208 and 210, together with the red diode 212.

The sixth light signal 116f is associated with the range Q9 and is made up of the green diode 210 together with the two red diodes 212 and 214.

The seventh light signal 116g, is associated with the ranges Q10 and Q11 and is made up of the three red diodes 212, 214, 216.

Furthermore, the range Q1 is associated with the light signals 16a and 16g which are both activated simultaneously. The ranges Q2 and Q3 associated with the light signal 16a differ in that the light signal 16a is made to flash in different manners.

For the range Q11, the light signal 16g is flashing.

The range Q12 is associated with no light signal (all of the diodes are off).

Preferably, the interface further includes a memory for storing moving bar sequences, i.e. sequences for flashing the diodes in succession. For this purpose, these moving bar sequences may be used for flashing in the ranges Q2, Q3, and Q4.

The vertical axis represents variation in the difference ε and also the bottom and top limits of each of the ranges of values Q.

This second embodiment constitutes a preferred but non-limiting application example.

1. A method of visually representing the variation over time of a current difference between a real value of a parameter and an optimum value therefore, the method making use of at least three activatable light signals, said method comprising:
a reception step of receiving the current difference;
a definition step during which at least three contiguous ranges of values are defined and each of these ranges of values is associated with a respective one of the light signals;
a determination step of determining the current range of values as the range of values in which the current difference lies;
a first transition step that is performed if the current range of values is contiguous with a prior range of values, in which step, after a first delay has elapsed, the signal associated with the prior range of values is deactivated and the light signal associated with the current range of values is activated; and
a second transition step that is performed if the current range of values is distinct from the prior range of values and if it is not contiguous with the prior range of values, during which step, after a second delay has elapsed, the light signal associated with the prior range of values is deactivated and the light signal associated with an intermediate range of values corresponding to a range of values contiguous with the prior range of values, is activated, and then after a third delay has elapsed, the light signal associated with the intermediate range of values is deactivated and the light signal associated with the current range of values is activated.

2. A method according to claim 1, wherein the second delay is equal to the third delay.

3. A method according to claim 2, wherein the second delay is equal to half the first delay.

4. A method according to claim 1, wherein the sum of the second and third delays is equal to the first delay.

5. A method according to claim 1, wherein the first transition step is performed if the current difference (□) lies in a sub-range (P3′) of the current range of values (P3) that is not contiguous with the prior range of values (P2).

6. A method according to claim 1, wherein the first and second transition steps are not performed if the current difference is greater than a predetermined limit value.

7. A method according to claim 1, wherein the parameter comprises at least one magnitude, in particular a speed.

8. A method according to claim 1, wherein each of the ranges of values includes a bottom limit and a top limit that depend on the optimum value of the parameter.

9. A display interface including a device implementing the visual representation method according to claim 1, a receiver member for receiving a current difference, a calculation device for defining at least three ranges of values, and at least three light signal emitters associated with the ranges of values.

10. A display interface according to claim 9, wherein each of said light signal emitters is constituted by at least one light-emitting diode.

11. A urban vehicle for following a route, said urban vehicle including a display interface according to claim 9, a speed sensor for measuring a real speed of the vehicle, a memory containing a plurality of optimum speeds, a calculation member for calculating a current difference between the real speed and the optimum speed corresponding to the current position of the vehicle, and for transmitting it to the receiver member of said display interface.
